(19) United States
(12) Patent Application Publication
(10) Pub. No.: US 2007/0300067 A1
(43) Pub. Date: Dec. 27, 2007

(54) Notice of Revocation System for Revocable or Modifiable Documents

(75) Inventors: Christina Robertson, Denver, CO (US); Jennifer Rose Nemeth, Denver, CO (US)

Correspondence Address: KRAJEC PATENT OFFICES, LLC, 820 WELCH AVENUE, BERTHOUD, CO, 80513, US

(73) Assignee: Roselyn, LLC, Denver, CO (US)

(21) Appl. No.: 11/422,076

(22) Filed: Jun. 3, 2006

(51) Int. Cl. H04L 9/00

(52) U.S. Cl. 713/176

(57) ABSTRACT

A revocable or modifiable document is affixed with a unique identification that is stored in a database with a status indicator. The principal who executed the document may be able to monitor and change the status indicator. A third party who might rely on the document may query the database to ensure the status of the document prior to accepting the document at face value. In some cases, a system may monitor queries made by third parties and enable the principal or their representative to monitor any activities related to the document. Examples of such documents are not limited to but include medical, financial, and other powers of attorney, advanced directives, wills, living wills, trusts, and documents used in secured transactions

### BACKGROUND OF THE INVENTION

Revocable documents are often difficult to control and trace, with a prime example being financial powers of attorney. Such documents can give an agent wide reaching powers that a principal may need to monitor, control, or revoke over time. There are many cases where an agent has overstepped their bounds and has caused financial havoc for the principal. Specifically, there have been many cases in elder law where elderly persons have had their bank accounts mismanaged by agents who abused the power of attorney.

Third parties, such as banks or other institutions, businesses, persons often rely on a written power of attorney to issue funds from an account, open a loan, sell or purchase property, or conduct other transactions. In some cases, the third parties may be defrauded when a written power of attorney has been revoked, limited, or otherwise modified.

### SUMMARY OF THE INVENTION

A revocable or modifiable document is affixed with a unique identification that is stored in a database with a status indicator. The principal who executed the document may be able to monitor and change the status indicator. A third party who might rely on the document may query the database to ensure the status of the document prior to accepting the document at face value. In some cases, a system may monitor queries made by third parties and enable the principal or their representative to monitor any activities related to the document. Examples of such documents are not limited to but include medical, financial, and other powers of attorney, advanced directives, wills, living wills, trusts, and documents used in secured transactions

### BRIEF DESCRIPTION OF THE DRAWINGS

In the drawings,

FIG. 1 is a diagrammatic illustration of an embodiment showing a revocable document management process.

FIG. 2 is a diagrammatic illustration of an embodiment showing a revocable document management system.

FIG. 3 is a flowchart illustration of an embodiment showing a method for automated document creation.

FIG. 4 is a flowchart illustration of an embodiment showing a method for document creation.

FIG. 5 is a flowchart illustration of an embodiment showing a method for obtaining the status of a document by a third party.

FIG. 6 is an illustration of an embodiment showing a revocable document.

FIG. 7 is a flowchart illustration of an embodiment showing a method for monitoring the use of a revocable document.

### DETAILED DESCRIPTION OF THE INVENTION

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the subject matter as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

Throughout this specification, the term “comprising” shall be synonymous with “including,” “containing,” or “characterized by,” is inclusive or open-ended and does not exclude additional, unrecited elements or method steps. “Comprising” is a term of art which means that the named elements are essential, but other elements may be added and still form a construct within the scope of the statement. “Comprising” leaves open for the inclusion of unspecified ingredients even in major amounts.

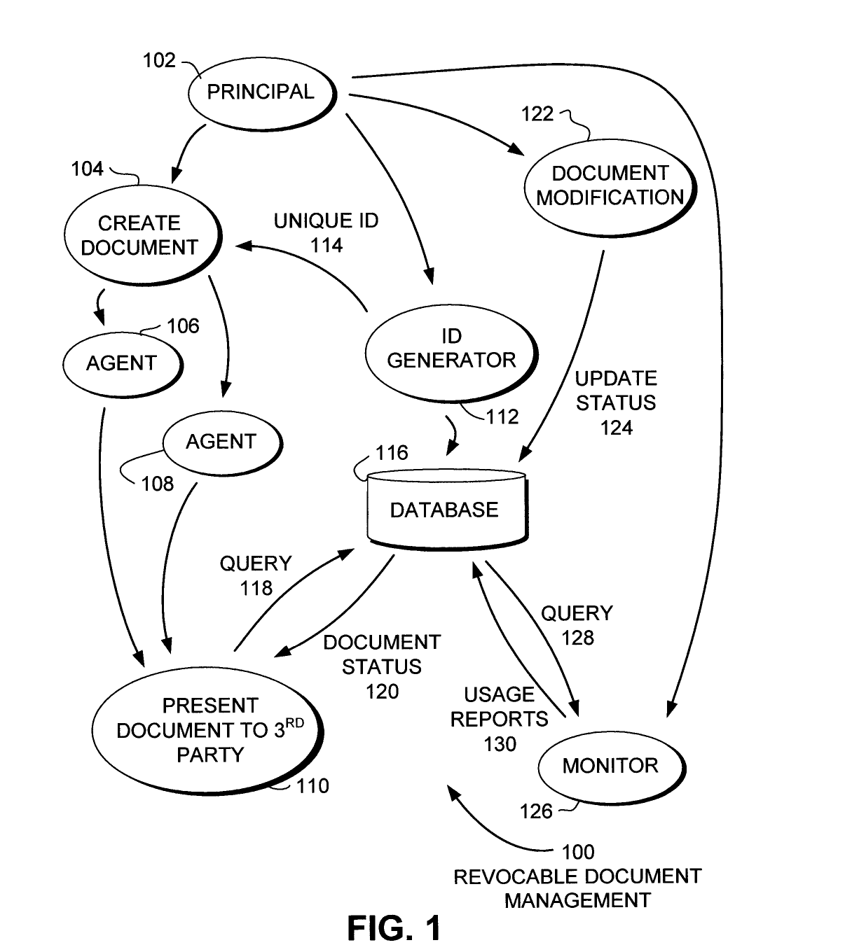

FIG. 1 illustrates an embodiment 100 showing a system for management of revocable documents. A principal 102 may create a document 104. The document may be a power of attorney or some other type of document. An agent 106 or 108 may present the document to a third party 110 in order to perform a transaction.

When the document is created, an identification generator 112 is queried and a unique identification is generated 114 and incorporated into the document 104. The unique identification is also stored in a database 116. When the document is presented to a third party 110, the third party may query 118 the database 116 to return the document status 120.

The principal 102 may use a document modification system 122 to update the status 124 of the document. The status may be, for example, that the document is revoked. In such a case, the third party may check the status, find out that the document has been revoked, and may not accept the document.

The principal 102 may also use a monitoring system 126 to periodically query 128 the database 116 to generate usage reports 130. In some cases, the usage reports 130 may be generated automatically.

The embodiment 100 illustrates a system for managing revocable documents. Such documents are created by a principal and are used by an agent in transactions with a third party. In many cases, a principal may wish that the document be useful for certain circumstances or for a limited period of time. The period of time may be extended or shortened based on circumstances as they occur over time. Further, some parameters set forth in the document may be modified, added, or eliminated during the useful life of the document.

Many documents may be executed, given to an agent, but may be difficult to effectively revoke. This is because the documents are out of the control of the principal and in the hands of one or more agents. The agents may use the documents to make financial, medical, or other arrangements when third parties rely on the document. Because the principal cannot notify all potential third parties if the document has been revoked, the agent may be able to maliciously or unwittingly continue using the document even when the principal wants to revoke or modify the document.

One situation where such a problem exists today is with financial powers of attorney executed by our elderly citizens. Often, a financial power of attorney or general power of attorney may be executed by an elderly principal so that an agent, such as a younger relative, may make some financial arrangements on behalf of the principal. Unfortunately, many elderly citizens are taken advantage of by unscrupulous agents with such a power of attorney.

In such a situation, the elderly principal has very little ability to effectively revoke or modify the document. An agent may rightfully make copies of the document which are generally treated with the same respect as the originals, and several people may be vested with powers afforded by the document. Third parties that rely on the document may enter into arrangements from which it may be costly for them to extract. Even if the principal requests that the documents and all copies be returned for revocation, obtaining all the copies may be difficult.

For example, an elderly gentleman may create a financial power of attorney and give it to his nephew. The nephew, full of youthful exuberance, may present the power of attorney to a bank to establish an account in his uncle's name but unbeknownst to his uncle, the principal. The bank may make a copy of the financial power of attorney and place it in their file. At some point, the uncle may wish to revoke the financial power of attorney and request that the nephew return all copies. Since the uncle does not know about the bank account, he does not know to notify the bank of the revocation. The bank may be relying on their copy of the financial power of attorney to continue to allow the nephew to exercise control of the bank account.

In this all too frequent scenario, the uncle may be able to access the database 116 to revoke the power of attorney. Because the third party, the bank in this example, may have an affirmative duty to periodically query 118 the database 116, any revocation of the power of attorney would be communicated to the bank regardless if the nephew notified the bank.

The document 104 may be any type of negotiable document, power of attorney, will, trust agreement, or any other document where a principal creates the document and an agent presents the document to a third party. By way of example, the document may be a living will, advanced directive, medical power of attorney, or other document giving an agent the power to make medical decisions for the principal. In another example, the document may give an agent the power to act in the financial affairs of the principal. Such a document may be a general power of attorney, a financial power of attorney, or a document used in a secured transaction, such as a negotiable instrument, bearer paper, promissory note, investment securities, documents of title, or any other document that gives an agent a direct or beneficial financial interest or power.

In some cases, the document may be a contract, will, or trust instrument.

The document 104 may contain a provision whereby a contract term or other adjustable or modifiable variable may be obtained through a query to the database 116. For example, a financial power of attorney may contain a maximum limit authorized for a transaction. In another example, a contract may contain a provision that adds certain limitations or requirements to the contract as defined in an entry in the database 116. The terms of the contract or agreement may change over time, and those terms may be valid for a predetermined period of time after the third party makes the query 118.

In some embodiments, the document 104 may transfer the responsibility or duty of verifying the status of the document to the third party. Rather than relying on the face of the document alone, the document may have terms that require that every time the document is relied upon, the third party must perform a query 118 and receive an appropriate document status 120 in order for the document to have effect.

Some embodiments may provide an authentication document along with the document status 120. The authentication document may include a time stamp, and may also include a unique identifier that is provided by the query system. The unique identifier may be an encrypted time stamp, a random number, or other identifier that may be used by the third party to authenticate the authentication document.

The identification generator, database, and other components of the overall system may be accessible through a web interface, a telephone interface, or any other type of interface. The principal and third party may each have a separate web interface through which each may perform their various functions. In some embodiments, a phone number, for example a tool free phone number, or the postal mail may be used by either or both the principal or the third party to perform their interactions with the database 116.

In some embodiments, the entire document may be created through a web interface, where a principal may enter his or her name, an agent's name, the nature of the document, and other information sufficient for the system to generate the entire document ready for the principal to print out on paper and sign or otherwise authenticate.

In other embodiments, an attorney or other document preparer may procure a series of preprinted labels with unique identification numbers for each label. When the attorney drafts the document, he or she may affix one of the preprinted labels on the document when the principal executes the document. In some cases, the label may include tamper resistant features, including anti-copying features, features that destroy or disfigure the document if the label were removed, or other features that would deter unauthorized tampering with the document. Some embodiments may include a label with a semi-transparent area having preprinted writing or images that is placed over other writing on the document. Such an embodiment may prevent an agent from copying the document and erasing or covering up the portions of the document that require the third party to check the status of the document.

The principal 102 may use a modification system 122 to update the status 124 of the document. The system may require the principal 102 to authenticate himself or herself to the system. For example, a principal may be required to enter a password or other authentication if the system has a web or other computer interface. In some cases, the principal may contact his or her personal attorney who may be authorized to update the status of the document. In such a case, the attorney may authenticate that the principal is indeed making the requested change.

In some situations, the principal 102 may be required to periodically update the status 124 to keep the document current. For example, a power of attorney may be valid for a three month period, but may be extended if and only if the principal uses the document modification system 122 to extend the period of validity. Such a term may be incorporated in the face of the document or may be a security feature of the database 116, where the document is rendered invalid without repeated contact by the principal.

The principal 102 may be able to monitor the activity of the document through a monitoring system 126 that performs a query 128 on the database 116 and returns a usage report 130. In some cases, a third party may be required to authenticate prior to receiving a document status 120. When performing the authentication, the third party may enter their name, business, address, phone number, nature of the inquiry, or any other information. Some or all of such information may be returned to the principal in the usage reports 130.

The monitoring system 126 may enable a principal 102 to track the usage of the document. Using the example of a power of attorney, the principal may wish to know where the power has been presented and for what purpose. In some cases, the monitoring function 126 may be used by government or other regulatory and monitoring authorities to periodically check for fraud.

The usage reports 130 may be triggered by a specific request of the principal, by a periodic report generator, or by predetermined triggers set in the database system. Examples of the triggers may be that a request for a certain size or type of transaction was attempted, that a certain frequency of requests were made, that a geographical boundary was exceeded, or any other type of abnormality. In some cases, every query by a third party may trigger an email message or other type of notification.

In some embodiments, the principal 102 may not interface directly with the various elements of the system, but an attorney or other representative acting on the principal's behalf may. For example, an attorney may draft the text of the document 104, but the attorney or a paralegal may access the identification generator 112 to retrieve the unique identification 114 that is incorporated in the text of the document. The attorney, acting on instructions from the principal, may engage the document modification system 122 to change the document status. Further, the attorney may perform periodic monitoring of the document usage and report back to the principal.

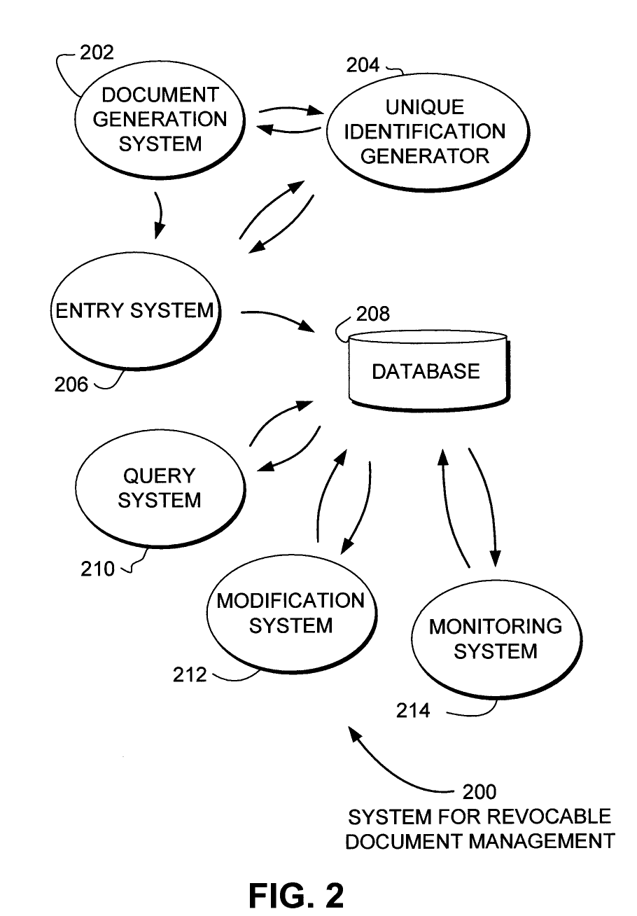

FIG. 2 is a diagrammatic illustration of an embodiment 200 showing a system for revocable document management. A document generation system 202 interacts with a unique identification generator 204 to produce a document. The entry system 206 may be used to enter the document information into the database 208. In some instances, the document generation system may be bypassed and a user may use the entry system 206 to interact with the unique identification generator 204 and store document information in the database 208. The embodiment 200 may also include a query system 210 useful for determining the status of the document from the database 208, a modification system 212 for changing the document status or other parameters in the database 208, and a monitoring system 214 for monitoring the activity relating to a document in the database 208.

The embodiment 200 may be a computerized and highly automated system whereby all interactions between the users of the system, such as the principal or third party, and the embodiment 200 are automated. Some embodiments, on the other hand, may use a manual system of recording, storing, and querying data. For example, a manual system may include a central repository where paper copies of each document and pertinent information about the document are stored in a bank of filing cabinets. A manual system may employ clerks who search the filing cabinets for the appropriate document in response to a query by a third party or principal.

The embodiment 200 may be system with a web-based interface, where any of the various users, such as principals, third parties, agents, principal's representatives, government regulators, or any other person may interface with the various components using a web browser on a computer connected to the Internet. In such a case, the document and data storage and retrieval may be highly automated.

Some embodiments may provide secondary mechanisms for interfacing with the system. For example, in lieu of or in addition to a web interface, a third party may be able to place a phone call to perform a query. The phone interface may be fully automated where the third party may press various keys on the phone or speak to activate menus, enter document identification, or perform any of the various steps. The phone interface may include a live operator who will converse with the third party to perform the interaction.

The specific form and technology used to interface with the embodiment 200 may be different for the specific applications, and those skilled in the art may use any useful technology to accomplish the goals of the system.

The document generation system 202 may be an automated system that takes specific information from the principal and other parties and generates a word-processed document. The document may be a predetermined form that is automatically filled out by the document generation system 202, or may have several different clauses, options, or other language that a principal or attorney may select during document creation. In some embodiments, the document generation system 202 may create legally binding documents without an attorney's involvement, while in other embodiments, an attorney may use such a system as a starting point for drafting a document for a client.

The unique identification generator 204 may generate a unique serial number or other identifier that can be used during the query process to determine the status of the document. In some cases, the unique identifier may be a single numeric, alpha-numeric, or text string that is assigned to the document. In other cases, an identifier may include images, shapes, or other human identifiable features. In still other cases, an identifier may include any type of machine readable feature, such as a barcode, magnetic strip, radio frequency identifier, or other feature that may be scanned by a device to provide an identifier. In yet other cases, the identifier may include an audio or visual playback device that transmits a prerecorded message, tone, or sequence that can be understood and interpreted by a human or a device.

The entry system 206 may be a dedicated web interface that enables a user to enter specific data about the document. During the document entry process, the entry system 206 may interact with the unique identification generator 204 and provide the unique identifier to the user of the entry system 206. The user may then add the unique identifier to the document. In some cases, the user may print a label with the unique identifier.

The database system 208 may be a computer operating any type of database management system in any useful configuration. The database 208 may include various forms of authentication, security, encryption, redundancy, or other systems, features, or mechanisms used by those skilled in the art for similar type databases. In some embodiments, the database 208 could include a paper copy repository or other non-electronic mechanism for document storage and retrieval.

The query system 210 may be any mechanism by which a third party may determine the status of the document. In some cases, the third party may be authenticated, such as by providing a name and email address. The third party may be authenticated by replying to an automated email, by entering a credit card, or by any other mechanism. In some cases, the query system 210 may afford an authenticated user a more detailed description or provide different features than with a non-authenticated user. For example, an authenticated user may be able to sign up for notifications if and when the document status changes, whereas a non-authenticated user may not be offered such an opportunity.

The query system 210 may monitor and record various information about a proposed transaction. For example, a query concerning a financial power of attorney may include the dollar amount of a transaction, the location of the transaction, and other details.

The modification system 212 is the means by which a principal may change the status of the document. The modification system 212 may require a high level of authentication of the principal or the principal's representative. The level of authentication may be commensurate with the legal powers enabled by the document. In some cases, two or more persons may be required to change the document status. For example, the principal and the principal's attorney may be required to authenticate any changes made to the document status. In the case of a document issued by a corporation, two or more people vested with the power to sign for the corporation may be required to authenticate any changes to the document.

After authenticating the principal or someone authorized to act on behalf of the principal, the modification system 212 may allow the principal to perform several different operations on the document. In the case of a revocable document, the principal may be able to completely revoke the document. In other cases, the principal may be able to add limitations, provisions or clauses, or remove such limitations, provisions or clauses.

The principal may be able to change different variable portions of the document. For example, if the document is a power of attorney, a provision in the power may state that the authorized amount of money that can be transacted with the power may the amount stored in the database 208. The principal may be able set such an amount through the modification system 212.

The monitoring system 214 may be useful for either a third party, a principal, or anyone else to monitor any activity that occurs with the document. The monitoring system 214 may be able to produce reports from each query made regarding the document, produce timelines of activities, or provide administrative functions. Reports may include the persons, businesses, or locations from where queries were made through the query system 210.

When an authenticated third party uses the monitoring system 214, the third party may be able to generate a report showing the status of all the documents with which the third party is associated, even if the documents are from different principals.

The monitoring system 214 may also provide alerts notifications based on certain activities or parameters. For example if a query is from a third party located outside a state boundary or if a query proposes a very large financial transaction, an alert may be generated. Such an alert may be sent to the principal, the principal's attorney, an executor of an estate, a court or other government agency, or anyone else.

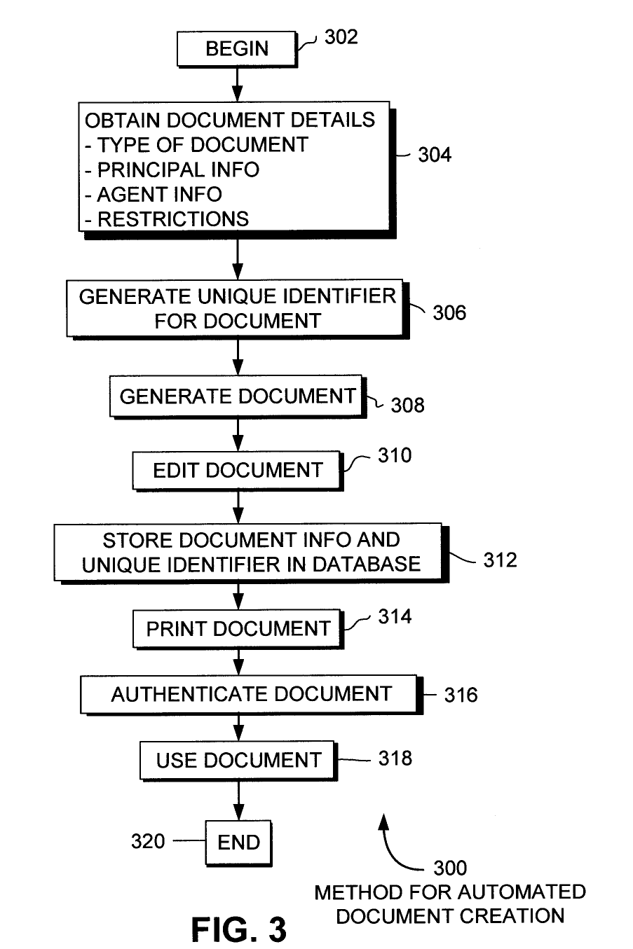

FIG. 3 is a flowchart illustration of embodiment 300 showing a method for automated document creation. The process begins in block 302. Details for the document are obtained in block 304, including the type of document, information about the principal, information about the agent, and any additional restrictions. In block 306, a unique identifier is generated for the document, and in block 308, the document is generated. In some cases, the document may be edited in block 310. Information about the document, as well as the unique identifier for the document, are stored in a database in block 312. The document is printed in block 314, authenticated in block 316, and used in block 318. The process ends in block 320.

The embodiment 300 illustrates how an automated document creation system may be used to create a revocable document. The method may be used to generate legally binding documents, such as a financial power of attorney, a general power of attorney, a trust instrument, a document used in a secured transaction, a medical power of attorney, an advanced directive, an organ donor registration, a living will, a will, a contract, or any other document.

In some cases, a user may create the document through a web-based interface. By entering in the appropriate information to the website and selecting different options from the website, the user may create a printable document that is ready to be signed or otherwise authenticated by a principal. Such a system may be used by attorneys or paralegals in creating a first draft of a document that may be edited in block 310.

Because the document may be created by the system, much of the information necessary to create the system may be readily stored in a database for later retrieval by a third party. The information may include a status field. In some embodiments, the status field may be set to indicate that the document is not valid, and the principal may be required to authenticate himself or herself to the system in order to change the status field to indicate that the document is valid.

The document may include instructions for a third party. The instructions may include language that express or implies that the third party cannot rely on the document until a query has been successfully made to the database and the query returns a valid status. In such a case, the third party may rely on the face of the document at his or her own peril unless such a query is performed. The instructions may include a website address for a query system, a telephone number for a query system, or other directions for performing a query on the database.

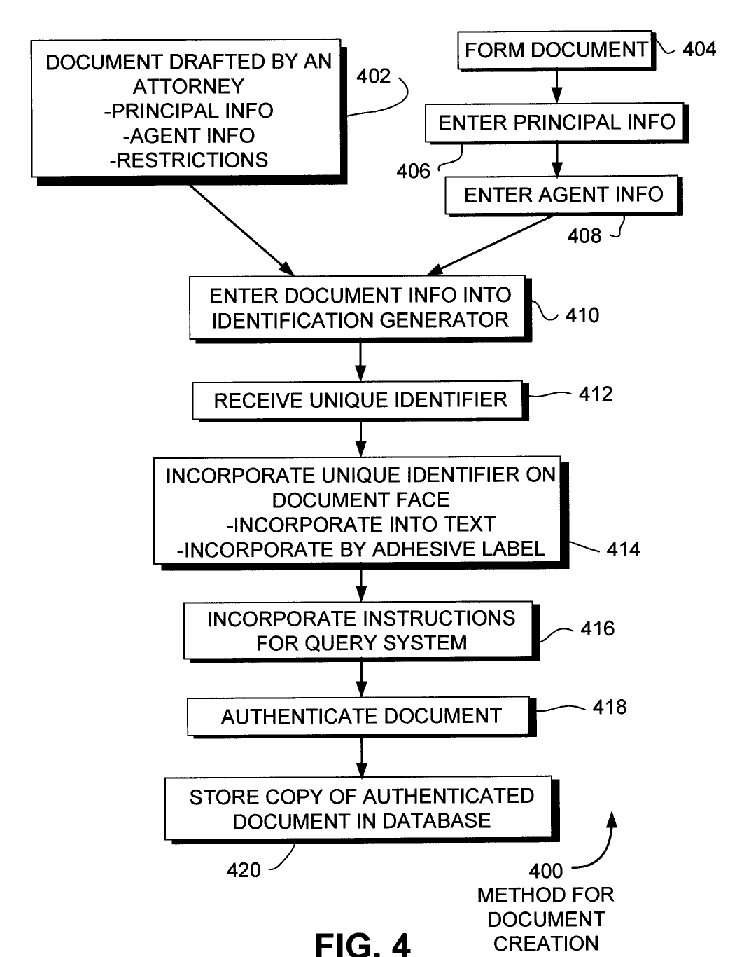

FIG. 4 is a flowchart illustration of an embodiment 400 showing a method for document creation. A document may be drafted by an attorney in block 402, where the attorney may incorporate the principal information, agent information, and any restrictions into the document. Alternatively, a document may be created by starting with a form document in block 404, entering information about the principal in block 406, and entering information about the agent in block 408. The document information may be entered into the identification generator in block 410 and a unique identifier for the document may be returned in block 412. The unique identifier may be incorporated onto the document face in block 414 by incorporating the identifier in the text of the document, or applying an adhesive label with the unique identifier onto the document. Instructions for operating the query system are incorporated in the document in block 416. The document is authenticated in block 418. A copy of the authenticated document may be stored in a database in block 420.

The embodiment 400 illustrates some of the techniques that can be used to generate a document that may be revoked through the systems of embodiments 100, 200, and the like. A unique identifier is incorporated into the document, and that identifier, along with other information about the document, may be stored in a database. A principal may update the status of the document or other parameters relating to the document in the database, from which a third party may gather up-to-date status of the document. The unique identifier may be used by the database to find the status or other parameters pertaining to the document.

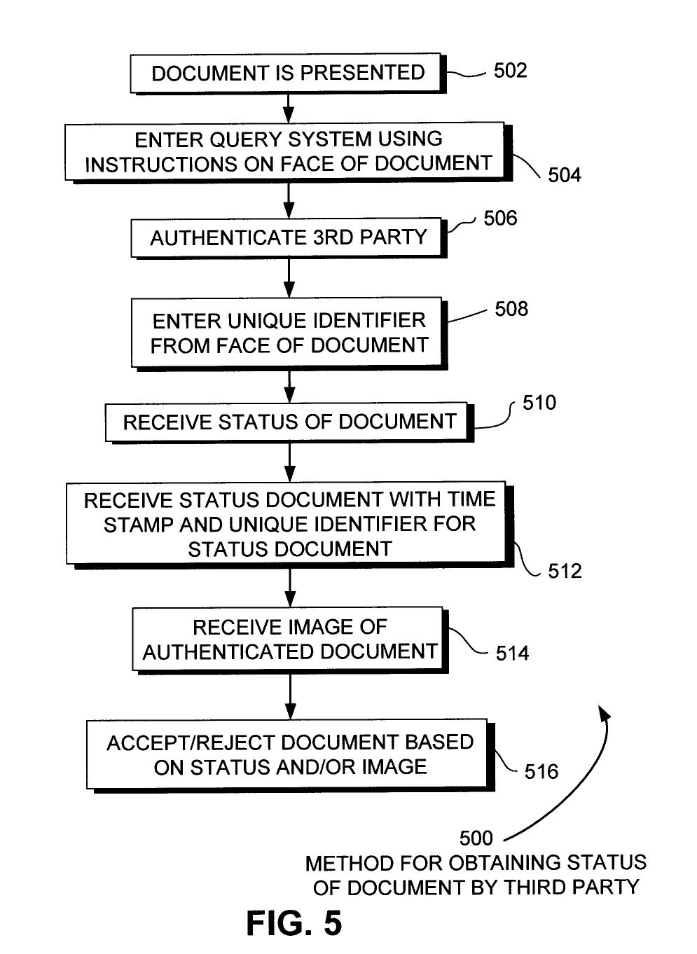

FIG. 5 is a flowchart illustration of an embodiment 500 showing a method for obtaining the status of a document by a third party. The document is presented to the third party in block 502. In block 504, the query system is entered by the third party using instructions on the face of the document. The third party is optionally authenticated in block 506, and the unique identifier is entered in block 508. The status of the document is received in block 510. A status document is received in block 512, where the status document may have a time stamp and a unique identifier. In block 514, the third party may receive an image of the original revocable document, and may accept or reject the document based on the status and/or image in block 516.

Embodiment 500 is a method by which a revocable document may be handled by a third party. In the embodiment, the third party uses instructions on the face of the document to perform a query. The query returns a status and may produce a status document and an image of the original revocable document. Based on these items, the third party may choose to rely on the document.

The process may shift the burden or risk of pursuing a transaction away from the third party, when the document is properly queried and a successful result is returned. In such a case, the third party may be given a timestamped document that may have a traceable and verifiable identifier that is issued when the query is made to the database. Such a status document may provide the third party with the assurance that the document is authentic so that a transaction may proceed. A copy of the status document, along with a record of the query, may also be stored in the database for later recall.

In some systems, an image of the original revocable document may be stored in the database. The image may be viewed or printed by a third party when a query is made, enabling the third party to inspect and verify that the presented document has not been altered or changed.

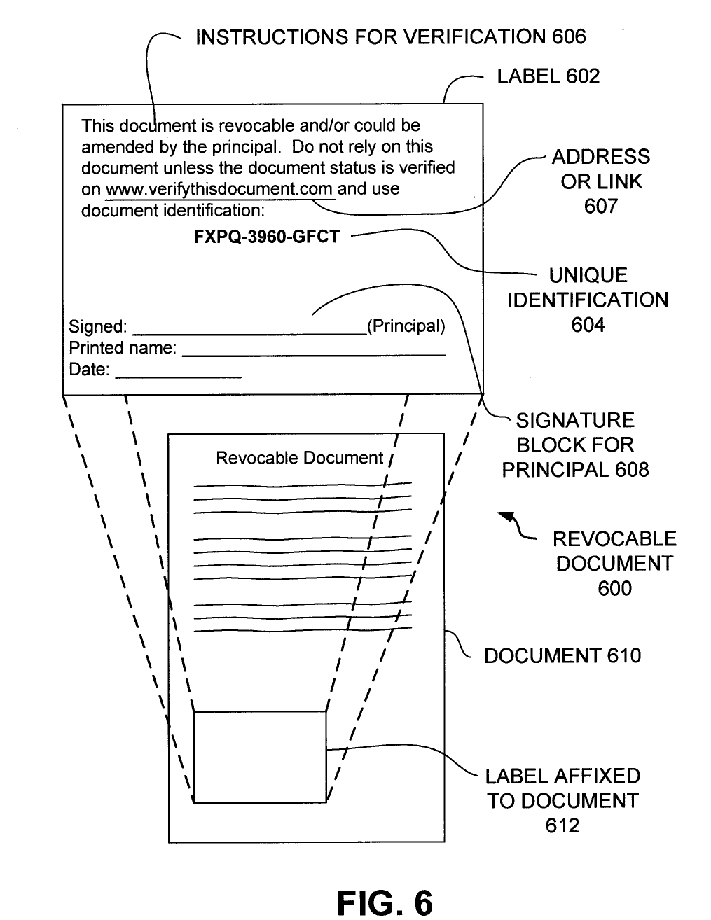

FIG. 6 is an illustration of an embodiment 600 showing a revocable document. A preprinted label 602 contains a unique identifier 604 and instructions for performing a verification query 606. The instructions include a web address or link 607. The label may also include a signature block for the principal 608. The label 602 may be affixed to the face of the revocable document 610 in the area 612.

The embodiment 600 uses a preprinted label to communicate the unique identifier 604 as well as instructions 606 for verifying the status of the document. The label may be preprinted well in advance with unique identifiers, but the drafter of the document 610 may enter the unique identifier and other particulars about the document 610 into an entry system that stores a record of the document 610 in a database.

In some cases, the label 602 may have several features that make it difficult for someone to fraudulently copy the document and erase the instructions 606 and unique identifier 604. For example, the label 602 may be printed on a transparent or semi-transparent label stock and have a background image or pattern printed on the label. The label may be placed over some text on the document 610, making it more obvious if the label were covered up or removed. In some embodiments, such a background image may only be readily visible when the document 610 is copied using a photocopier. In some embodiments, the label 602 may have a transparent portion that covers the principal's signature area.

The label 602 may have various other tamper-proof or tamper-resistant features. For example, the label 602 may be constructed so that any attempt to remove the label severely damages the underlying document.

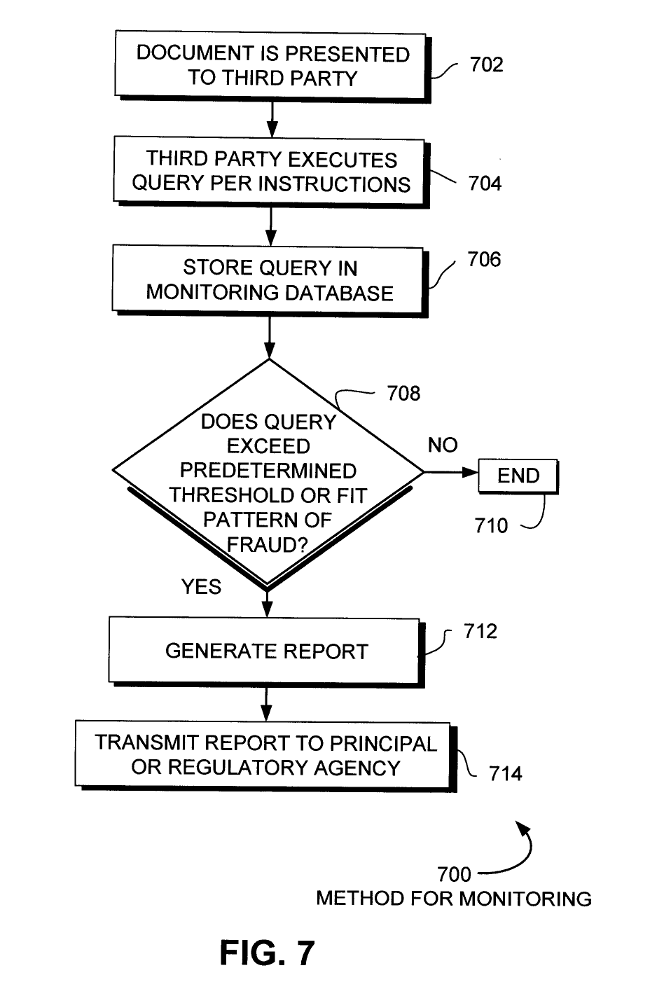

FIG. 7 is a flowchart illustration of an embodiment 700 showing a method for monitoring the use of a revocable document. The document is presented to a third party in block 702, whereupon the third party executes a query in block 704. The query is stored in a monitoring database in block 706. If the query does not exceed a predetermined threshold or fit a pattern of fraud in block 708, the process ends in block 710, otherwise a report is generated in block 712 and the report is transmitted to the principal or regulatory agency in block 714.

The embodiment 700 illustrates how the queries about a document may be stored, monitored, and various notifications generated if the query presents a potential problem. In some cases, the thresholds may be set so that every query generates a report that is viewed by the principal. In other cases, the query in block 708 may include sophisticated algorithms, pattern checking routines, or queries to various databases to determine if a query fits the potential for fraud. For example, a query from an offshore bank known for illegitimate or shady transactions may create an immediate notification that may be sent to a principal and possibly to governmental regulatory agencies.

The various embodiments disclosed herein are examples of how documents, including legally enforceable documents, may be created, used, and revoked. By using a database and query system, a principal that authorized a document may be able to serve notice to those third parties that potentially rely on the document. The notice may include whether or not the document has been revoked in its entirety, and the system may prevent the third party from relying on the document and entering into a transaction from which it should not have.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A system comprising:
a database;
an identification generation system adapted to generate a unique identification for a revocable document, said unique identification being attached to said document, said revocable document being authorized by a principal;
an entry system adapted to store said unique identification in said database;
a query system adapted to return a status for said revocable document using said unique identification;
a modification system adapted to modify said status and further adapted to authenticate said principal.

2. The system of claim 1 further comprising:
a monitoring system adapted to store a record for a query performed by said query system.

3. The system of claim 2 wherein said monitoring system is further adapted to notify said principal of said record.

4. The system of claim 1 wherein said revocable document is at least one of a group composed of: a financial power of attorney, a general power of attorney, a trust instrument, a document used in a secured transaction, a medical power of attorney, an advanced directive, an organ donor registration, a living will, and a will.

5. The system of claim 1 wherein said unique identification is attached to said revocable document by a label.

6. The system of claim 5 wherein said label comprises at least one of a group composed of: a tamper resistant feature and at least a portion that is at least semi-transparent.

7. The system of claim 5 wherein said adhesive label is attached to copies of said revocable instrument.

8. The system of claim 1 wherein said identification system comprises a world wide web interface.

9. The system of claim 1 wherein said identification system is adapted to create said revocable document by a method comprising:
taking said principal's name;
taking an agent's name;
generating text for said revocable document;
incorporating said unique identification into said text of said revocable document; and
delivering said text in a printable format.

10. The system of claim 9 wherein said method further comprises:
incorporating a reference for said query system in said text for said revocable document.

11. The system of claim 10 wherein said reference for said query system comprises a website address through which said query system may be engaged.

12. The system of claim 9 further comprising:
delivering said text in an editable format.

13. The system of claim 9 wherein said identification system comprises a web interface.

14. The system of claim 1 wherein said query system is further adapted to display an image of said revocable document.

15. The system of claim 1 wherein said query system is further adapted to be operated through at least one of a group composed of: a web interface, a telephone interface, and an email interface.

16. The system of claim 1 wherein said query system is further adapted to generate a status document showing said status and having a second unique identifier.

17. The system of claim 1 wherein said modification system is adapted to enable said principal to amend said revocable document.

18. A method comprising:
taking a principal's name;
taking an agent's name;
generating the text of a revocable document, said text comprising said principal's name and said agent's name;
incorporating a unique identification on said revocable document;
storing said unique identification and a status in a database; and
incorporating an address on said revocable document, said address being to a website adapted to query said database and return said status.

19. The method of claim 18 further method comprising:
receiving a query for a status for a revocable document, said query being to a database comprising a unique identifier that is incorporated on the face of said revocable document;
storing said query; and
generating a notification of said query.

20. A revocable document comprising:
an authentication by a principal for said document;
a unique identifier attached to the face of said document, said unique identifier being stored in a database, said database comprising a status related to said document, said database being further accessible by said principal through a modification system such that said principal may change said status of said document, said unique identifier being generated using an identification system; and
a statement on said document transferring a duty to a third party to perform a query on said database to obtain said status prior to relying on said document, said query being performed using a query system.
